(19) United States
(12) Patent Application Publication
(10) Pub. No.: US 2020/0401442 A1
(43) Pub. Date: Dec. 24, 2020

(54) INFORMATION PROCESSOR, METHOD FOR CONTROLLING INFORMATION PROCESSOR, AND NON-TRANSITORY COMPUTER-READABLE STORAGE MEDIUM FOR STORING CONTROL PROGRAM FOR INFORMATION PROCESSOR

(71) Applicant: FUJITSU LIMITED, Kawasaki-shi (JP)

(72) Inventor: Go Endo, Kawasaki (JP)

(73) Assignee: FUJITSU LIMITED, Kawasaki-shi (JP)

(21) Appl. No.: 16/892,340

(22) Filed: Jun. 4, 2020

(30) Foreign Application Priority Data
Jun. 20, 2019 (JP) 2019-114706

(51) Int. Cl. G06F 9/48

(52) U.S. Cl. CPC G06F 9/4818; G06F 9/4881; G06F 9/485

(57) ABSTRACT

An information processing apparatus includes: a control circuit; an interface circuit; and an information processing circuit, wherein the control circuit is configured to: execute a first processing that includes causing the information processing circuit to individually execute a plurality of divided first control commands as one processing unit in a predetermined execution order, via the interface circuit; execute an interrupt detection processing that includes detecting an interrupt issued from the information processing circuit or the interface circuit; execute a command generation processing that includes generating a second control command for identifying an interrupt factor of the interrupt detected by the interrupt detection processing; and execute a processing order change processing that includes preferentially arranging the second control command generated by the command generation processing over the unexecuted first control commands to change the execution order.

### CROSS-REFERENCE TO RELATED APPLICATION

This application is based upon and claims the benefit of priority of the prior Japanese Patent Application No. 2019-114706, filed on Jun. 20, 2019, the entire contents of which are incorporated herein by reference.

### FIELD

The present invention is related to an information processor, a control method for the information processor, and a non-transitory computer-readable storage medium for storing a control program for the information processor.

### BACKGROUND

A server device may have a SVP board equipped with a processor called a service processor (SVP) that is a computer subsystem operating independently from a main unit of the server device including a central processing unit (CPU) and the like. The SVP executes a firmware for controlling a server, which is called server control firm, to perform a system control function, an operator console function, and a diagnosis function. The SVP board is coupled to a server board equipped with a CPU and a memory in the main unit of the server device via a system controller. The system controller operates independently from the main unit of the server device. An input/output (IO) processor is also mounted on the server board Hereinafter, the mere CPU refers to the CPU in the main unit of the server device.

A program of a server control firmware is stored in a nonvolatile memory on the SVP board. The program is read from the nonvolatile memory to activate the server control firmware.

There are two control modes of the server device. One mode is a command execution mode in which the server control firmware mainly executes a control command and controls the server. Another mode is an interrupt mode in which the server device mainly interrupts the control firmware and causes the server control firmware to execute the control command. In executing the control command, the server control firmware may execute a plurality of control commands collectively for the server device, One interface coupling a server control device to the server device is often used. Thus, in the interrupt mode, when the server device causes the server device to execute a plurality of control commands collectively, the collected control commands are processed and then, a control command generated by an interrupt from the device is executed.

In the command mode, two types of interface commands—an Inter-Integrated Circuit (I2C) command and a Joint Test Action Group (JTAG) command are used. The SW performs direct memory access (DMA)-transfer concerning a packet of the control command to a system control interface (SCI) via a Peripheral Component Interconnect Express (PCIe), The system controller receives the control command transmitted from the SVP and executes the command for the main unit of the server device. The system controller receives a notification that the command has been executed from the CPU. The system controller sends a notification that DMA has been completed to an SVP firmware. The SVP firmware receives the notification that DMA has been completed, and finishes command execution.

In the interrupt mode, there are three types of interrupts—an interrupt according to a failure notification, and interrupts according to instructions from an operating system (OS) using a CPU substitution command and an IO command. The failure notification is a notification of a device failure, and the SVP firmware receives the notification and performs processing corresponding to the notification. The CPU substitution command is a command for causing the SVP firmware in place of the CPU to execute the command from the OS, such as acquisition of system configuration. The IO command is a command for causing a terminal coupled to the SVP board to display a screen of the OS, and the SVP firmware to perform processing in response to an operation of a console or a printer of the OS.

In the interrupt mode, the CPU detects a system control interrupt, and notifies the system control interrupt to the SVP firmware via the system controller. The system controller and the SVP firmware receives an input of the system control interrupt. When detecting the system control interrupt, the SVP firmware executes the control command, and detects a factor for the system control interrupt. The system controller transmits the system control interrupt as a dedicated signal to the SVP firmware. Since the system control interrupt is the dedicated signal, the SVP firmware may detect the system control interrupt command even during execution of the control command.

According to a known technique, a parallel computer receives one command consisting of a plurality of commands, and breaks down the one command into the commands for logical processors in the parallel computer for processing. According to another known technique, at the occurrence of a trouble, trouble information is saved in a saving area and then, notifies a trouble report to a central processor and transfers the trouble information in response to an instruction from the central processor. According to another known technique, at the occurrence of a trouble, the trouble is classified according to the affection level to the system, and the serious trouble if any is notified, According to another known technique, when a trouble occurs in a DMA mechanism, the DMA mechanism is switched to another DMA mechanism having no trouble, which is used for data transfer.

Examples of the related art include Japanese Laid-open Patent Publication Nos. 09-244893, 05-28062, 05-224996, and 04-235656.

### SUMMARY

According to an aspect of the embodiments, an information processing apparatus includes: a control circuit; an interface circuit; and an information processing circuit, wherein the control circuit is configured to: execute a first processing that includes causing the information processing circuit to individually execute a plurality of divided first control commands as one processing unit in a predetermined execution order, via the interface circuit; execute an interrupt detection processing that includes detecting an interrupt issued from the information processing circuit or the interface circuit; execute a command generation processing that includes generating a second control command for identifying an interrupt factor of the interrupt detected by the interrupt detection processing; and execute a processing order change processing that includes preferentially arranging the second control command generated by the command generation processing over the unexecuted first control commands to change the execution order.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a system configuration view illustrating an information processing system.

FIG. 2 is a view illustrating summary of processing at inputting of a control command.

FIG. 3 is a view illustrating summary of processing at occurrence of an interrupt.

FIG. 4 is a table illustrating devices in which each interrupt occurs.

FIG. 5 is a block diagram illustrating an information processing system in accordance with Embodiment 1.

FIG. 6 is a view illustrating an example of descriptor registration form.

FIG. 7 is a view illustrating the state where a normal processing descriptor and an interrupt processing descriptor are stored in a shared memory.

FIG. 8 is a table illustrating the priority of each interrupt.

FIG. 9 is a table illustrating interfaces used for factor detection.

FIG. 10 is a view illustrating an example of a descriptor register of a system controller.

FIG. 11 is a flowchart of the processing of control commands by an SVP board.

FIG. 12 is a flowchart illustrating details of the processing at the occurrence of an interrupt.

FIG. 13 is a block diagram illustrating an information processing system in accordance with Embodiment 2.

### DESCRIPTION OF EMBODIMENT(S)

The number of DMA controllers mounted in the system controller is often one. As soon as the SVP firmware detects the system control interrupt, the SVP firmware desirably detects an interrupt factor. In detecting the interrupt factor, the SVP firmware acquires the interrupt factor from the DMA controller. At this time, since the only one DMA controller is provided, the SVP firmware executes a system interrupt command after execution of the control command being processed. For example, when the plurality of control commands are collectively executed, a delay may become large. Thus, the SVP firmware may hardly achieve a performance target.

Even when the known technique of dividing one set of collected control commands into the individual commands for each logical processor and processing the commands is used, it is difficult to detect the interrupt factor without waiting for the completion of execution of the control commands. The failure notification is one of the interrupt factors for the system control interrupt, but in the known technique of transferring the trouble information in response to the instruction from the central processor and the known technique of notifying the trouble according to the level, the relationship between the failure notification and the control command is not considered. Thus, according to these techniques, it is difficult to reduce time taken to detect the interrupt factor, improving processing performances. According to the known technique of duplexing the DMA mechanism, it is not considered to detect the interrupt factor during execution of the control command, making it difficult to reduce time taken to detect the interrupt factor and improve processing performances.

The technique of the present disclosure is devised in consideration of the above-mentioned circumstances, and its object is to provide an information processor, a control method for the information processor, and a control program for the information processor that improve processing performances.

From one aspect, the present invention may improve processing performances.

Embodiments of an information processor, a control method for the information processor, and a control program for the information processor of this application will be described below with reference to figures. The information processor, the control method for the information processor, and the control program for the information processor of this application are not limited to the embodiments.

### Embodiment 1

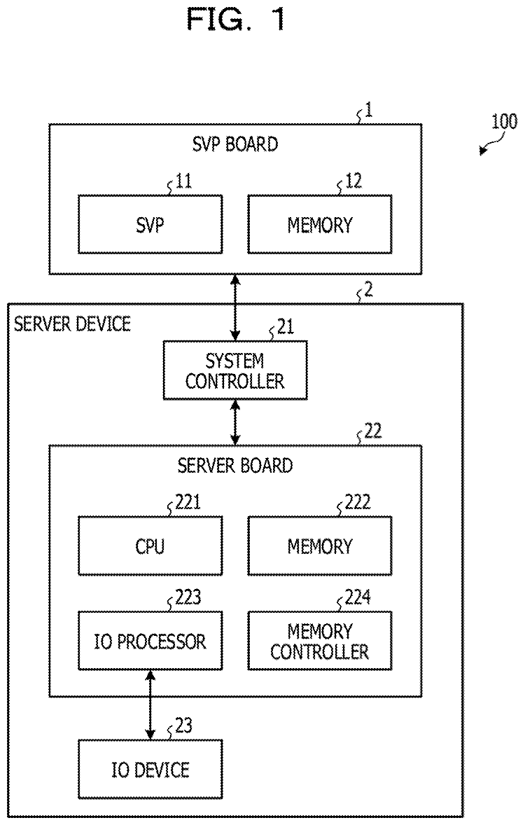

FIG. 1 is a system configuration view illustrating an information processing system. An information processing system 100 according to the present embodiment has an SVP board 1 and a server device 2.

The server device 2 has a system controller 21, a server board 22, and an IO device 23. For example, a CPU 221, a memory 222, an JO processor 223, and a memory controller 224 are mounted on the server board 22. Hereinafter, various devices mounted on the server board 22, such as the CPU 221, the memory 222, the IO processor 223, and the memory controller 224 are referred to as a controlled device 200. A monitor and a hard disc, although not illustrated, are coupled to the IO processor 223.

In the present embodiment, the SVP board 1 is described as a device separated from the server device 2 and however, the SVP board 1 may be mounted on the server device 2. The server device 2 on which the information processing system 100 or the SVP board 1 is an example of “information processor”. The SVP board 1 is an example of “control unit” and “control device”. The system controller 21 is an “interface unit” and “interface device”. The server board 22 is an example of “information processing unit” and “arithmetic processing device”.

The controlled device 200 communicates with the system controller 21 using I2C or JTAG. When receiving the control command using I2C or JTAG, the controlled device 200 performs processing instructed in the control command, and returns a response to the system controller 21. For example, the memory controller 224 stores data transmitted from the system controller 21 by DMA transfer in the memory 222. When an interrupt such as a failure notification, a CPU substitution command, or an IO command occurs, the controlled device 200 outputs an interrupt notification to the system controller 21.

The SVP board 1 is coupled to the server board 22 via the system controller 21. The SVP board 1 has an SVP 11 and a memory 12. The SVP board 1 is coupled to a terminal device not illustrated. The SVP 11 externally controls the CPU 221, the IO processor 223, and the like, which are mounted on the server board 22. The SVP 11 inputs the control command to the server board 22 via the system controller 21, thereby controlling the CPU 221, the IO processor 223, and the like on the server board 22.

The SVP 11 displays a screen of an OS operated by the CPU 221 on a screen of the coupled terminal device. The SVP 11 outputs the input to the screen displayed on the terminal device to the server device 2, thereby achieving the operation of the server device 2 using the terminal device.

The SVP 11 receives the interrupt notification generated from the CPU 221, the IO processor 223, or the like on the server board 22 from the system controller 21 to detect an interrupt. When detecting the interrupt, the SVP 11 outputs the control command to the server board, and detects an interrupt factor. Then, the SW 11 performs the processing corresponding to the detected interrupt factor. The detection of the interrupt factor may be also referred to as gathering of the interrupt factor.

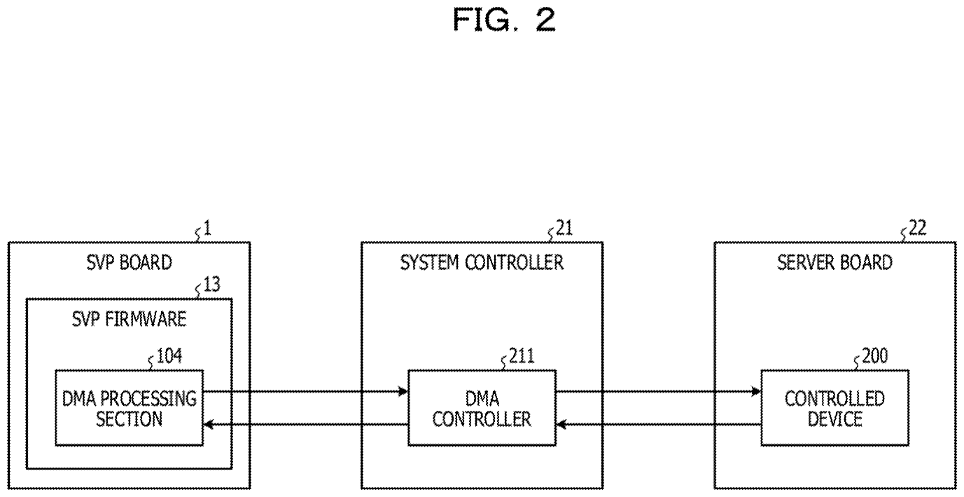

FIG. 2 is a view illustrating summary of the processing at inputting of the control command. On the SW board 1, the SVP 11 executes a program, thereby operating an SW firmware 13. The SVP firmware 13 operates a DMA processing section 104. The DMA processing section 104 issues a packet of the control command to a DMA controller 211 of the system controller 21, to cause the DMA controller 211 to transmit/receive data to/from the server board 22 by a DMA transfer. The DMA processing section 104 communicates with the DMA controller 211 using I2C or JTAG.

The DMA controller 211 executes the control command transmitted from the DMA processing section 104 to transmit/receive the data to/from the memory 222 of the controlled device 200 by the DMA transfer. The DMA controller 211 sends the notification that DMA transfer has been completed to the DMA processing section 104. The DMA controller 211 communicates with the controlled device 200 using J2C or JTAG.

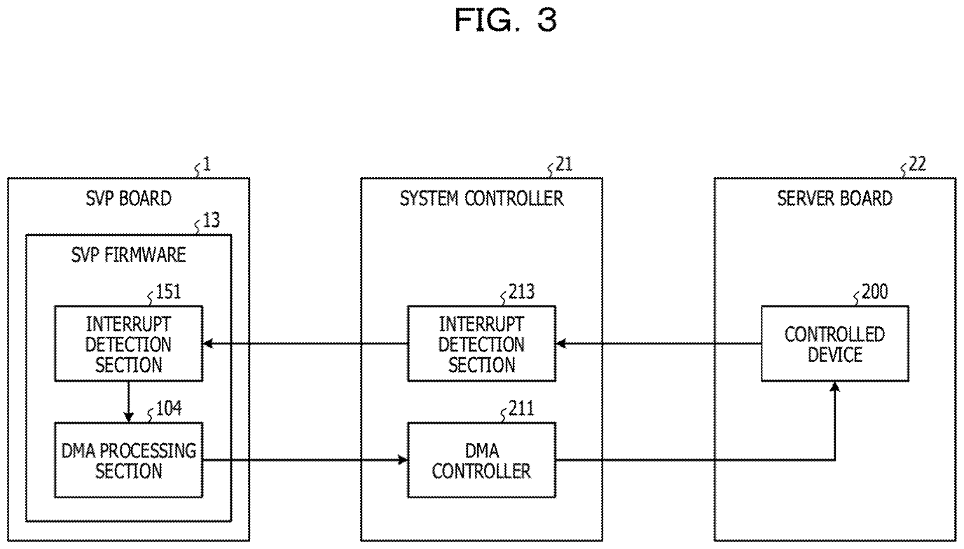

FIG. 3 is a view illustrating summary of processing at occurrence of the interrupt. In the case of interrupt, an interrupt notification is issued from the controlled device 200. An interrupt detection section 213 of the system controller 21 receives the interrupt notification to detect the interrupt, and transfers the received interrupt notification to the SVP firmware 13. An interrupt detection section 151 operated by the SVP firmware 13 receives the interrupt notification to detect the interrupt, and notifies the occurrence of the interrupt to the DMA processing section 104. The DMA processing section 104 generates a control command for detecting the interrupt factor, and transmits the generated control command to the DMA controller 211. The DMA controller 211 executes the received control command for detecting the interrupt factor to detect the interrupt factor for the controlled device 200.

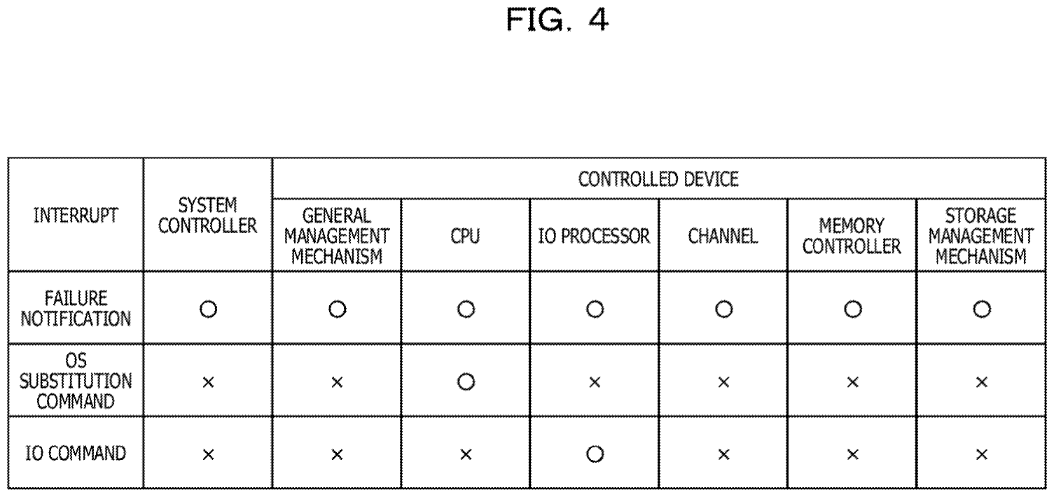

Referring to FIG. 4, devices in which the interrupt occurs will be described. FIG. 4 is a table illustrating the devices in which each interrupt occurs.

A general management mechanism in FIG. 4 collectively manages the CPU 221, the memory 222, the IO processor 223, and the memory controller 224, and relays control of the system controller 21. A channel is a management mechanism that collectively manages various IO devices coupled to the IO processor 223. A storage management mechanism manages a storage device coupled to the server device 2.

As illustrated in FIG. 4, the failure notification is issued from all of the system controller 21, the general management mechanism, the CPU 221, the IO processor 223, the channel, the memory controller 224, and the storage management mechanism. The OS substitution command is issued from the CPU 221. The IO command is issued from the IO processor 223.

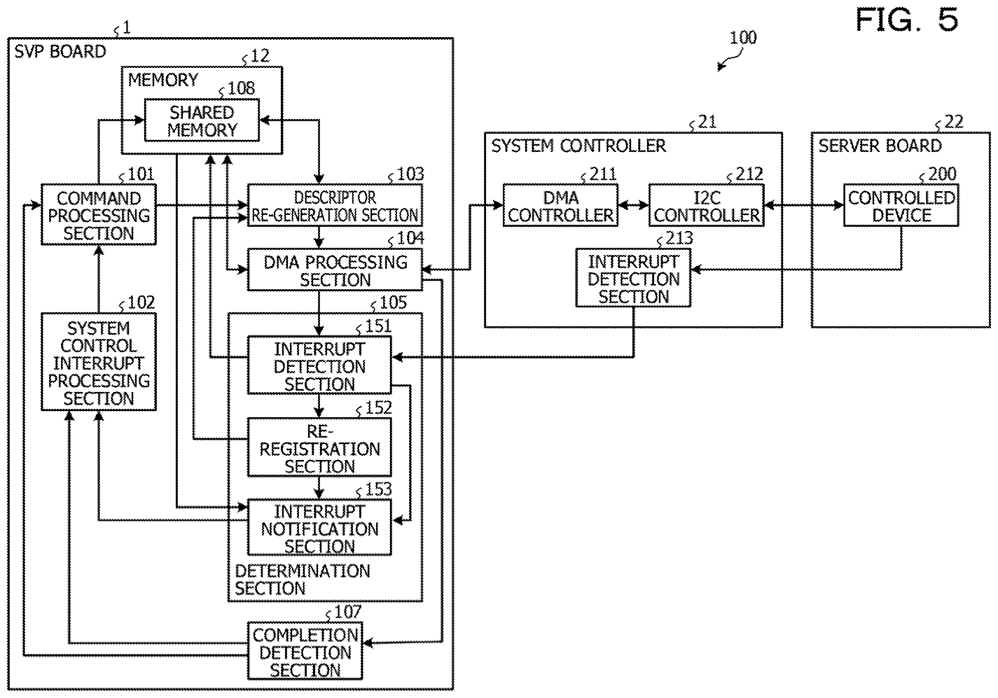

Referring to FIG. 5, details of interrupt processing of the SVP board 1 in accordance with the present embodiment will be described below. FIG. 5 is a block diagram illustrating the information processing system in accordance with Embodiment 1.

The SVP board 1 has a command processing section 101, a system control interrupt processing section 102, a descriptor re-generation section 103, a DMA processing section 104, a determination section 105, a memory 106, and a completion detection section 107. The command processing section 101 and the system control interrupt processing section 102 operate in a user layer of the SVP firmware 13. The descriptor re-generation section 103, the DMA processing section 104, the determination section 105, the memory 106, and the completion detection section 107 operate in a driver layer of the SVP firmware 13.

The command processing section 101 receives the control command from the terminal device. This control command is inputted as a unified command consisting a plurality of control commands to the command processing section 101. Each control command included in the unified command is an example of “first control command”. The collected processing performed according to all control commands included in the unified command corresponds to “one processing unit”.

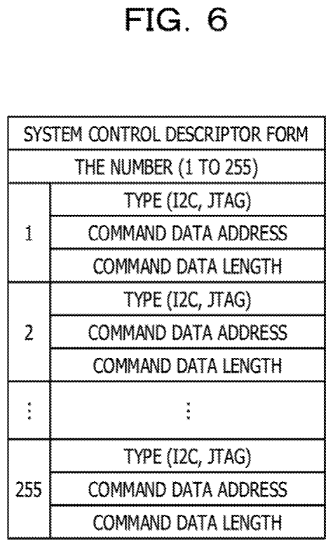

The command processing section 101 secures a memory used for DMA as a shared memory 108. The command processing section 101 notifies the shared memory 108 to the descriptor re-generation section 103. The command processing section 101 generates a normal processing descriptor in the form illustrated in FIG. 6. The command processing section 101 registers descriptor information and command data for executing the unified command in the generated normal processing descriptor in the shared memory 108. FIG. 6 is a view illustrating an example of a descriptor registration form. As illustrated in FIG. 6, the number of control commands, as well as the type, command data address, and data length of each control command are registered in the descriptor.

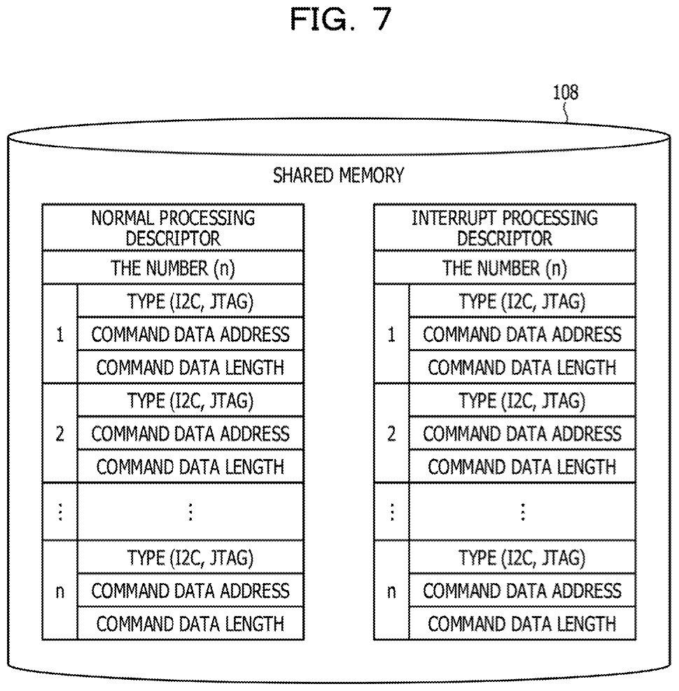

In this case, the command processing section 101 generates the normal processing descriptor and registers the normal processing descriptor in the shared memory 108 as illustrated in FIG. 7. FIG. 7 is a view illustrating the state where the normal processing descriptor and an interrupt processing descriptor are stored in the shared memory. The command processing section 101 outputs a driver call for instructing the execution of the control commands registered in the descriptor in the shared memory 108 to the command processing section 101.

When an interrupt of the failure notification occurs, the command processing section 101 receives the control command for detecting the interrupt factor from the system control interrupt processing section 102. When an interrupt of the CPU substitution command or the IO command occurs, the system control interrupt processing section 102 receives the control command for executing the interrupt processing corresponding to the interrupt factor stored in the memory 106. When the interrupt factor is notified during the execution of the unified command, the command processing section 101 registers the unified command registered in the normal processing descriptor stored in the shared memory 108, followed by the control command inputted from the system control interrupt processing section 102.

Then, the command processing section 101 receives a notification that the unified command has been executed from the completion detection section 107. The command processing section 101 outputs a driver call for instructing the execution of the command registered following the unified command to the command processing section 101.

The descriptor re-generation section 103 receives the notification of the shared memory 108 from the command processing section 101. As illustrated in FIG. 7, the descriptor re-generation section 103 creates an interrupt processing descriptor in the shared memory 108. As illustrated in FIG. 7, the interrupt processing descriptor is generated in the shared memory 108 as a descriptor that is different from the normal processing descriptor.

Returning to FIG. 5, description will be made. The descriptor re-generation section 103 receives a driver call from the command processing section 101. The descriptor re-generation section 103 divides the normal processing descriptor registered in the shared memory 108 in units of control command, and instructs the DMA processing section 104 to sequentially perform DMA for each of the divided control commands.

The descriptor re-generation section 103 receives the control command for identifying the device, the control command for identifying the target type, or the control command for detecting the interrupt factor from a re-registration section 152. When receiving an input from the re-registration section 152 during the execution of each of the control commands divided from the unified command, the descriptor re-generation section 103 activates the interrupt processing descriptor in the shared memory 108, The descriptor re-generation section 103 registers the control command for performing designated processing in the interrupt processing descriptor, and re-generates the descriptor so as to execute the command for performing the designating processing in next processing. The descriptor re-generation section 103 instructs the DMA processing section 104 to perform DMA for each of the commands registered in the interrupt processing descriptor.

When receiving the control command for identifying the device and the control command for detecting the target type, the descriptor re-generation section 103 stops the processing of the descriptor that registers the unified command in the shared memory 108 therein until the received control commands have been executed. When receiving the control command for detecting the interrupt factor, the descriptor re-generation section 103 stops the processing of the descriptor that registers the unified command in the shared memory 108 therein until the interrupt factor detection processing has been executed. For example, the descriptor re-generation section 103 re-generates the descriptor such that each control command about the interrupt processing is executed between the control commands generated by dividing the unified command. At this time, the descriptor re-generation section 103 stores the lastly-executed control command in the normal processing descriptor. When all commands registered in the interrupt processing descriptor have been executed, the descriptor re-generation section 103 restarts the processing of the normal processing descriptor from the stop position. The descriptor re-generation section 103 is an example of “processing order change section”.

The DMA processing section 104 receives commands and an instruction to perform DMA from the descriptor re-generation section 103. The DMA processing section 104 sets a descriptor register to the DMA controller 211 of the system controller 21. The DMA processing section 104 executes the command. When executing the control command for detecting the interrupt factor, the DMA processing section 104 stores the interrupt factor acquired by executing the command as a lookahead factor in the memory 106. The DMA processing section 104 outputs response results of the control command for identifying the device and the control command for detecting the target type to the interrupt detection section 151 of the determination section 105. The DMA processing section 104 is an example of “processing section”.

The determination section 105 determines whether or not interrupt priority processing is performed. The determination section 105 has the interrupt detection section 151, the re-registration section 152 and an interrupt notification section 153.

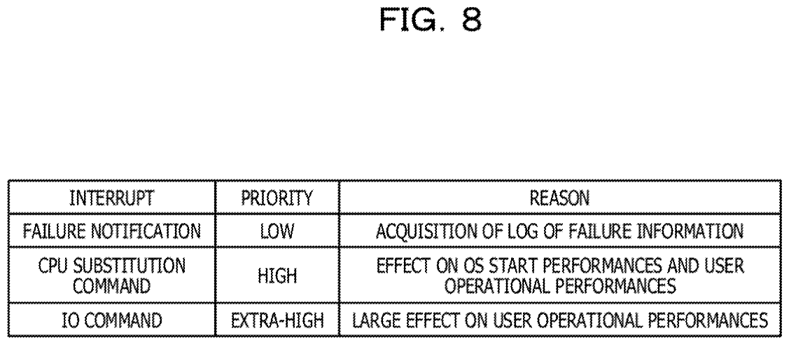

The interrupt detection section 151 previously has types of the interrupt having high priority and the interrupt having low priority. FIG. 8 is a table illustrating the priority of each interrupt.

For example, the types of the interrupt includes the failure notification, the CPU substitution command, and the IO command. Since a large log is acquired from the server board 22 in the interrupt processing, the failure notification takes much time. Since the failure notification includes the acquisition of the log of the failure information as described above, the interrupt detection section 151 stores the priority of the failure notification as low. For the CPU substitution command, storage information is acquired at activation of the server device 2 and transmitted to the CPU 221 in the interrupt processing. In this case, since response time is limited, the response is desirably sent to the server device 2 as soon as possible, Since the CPU substitution command affects OS start performances and user operational performances, the interrupt detection section 151 stores the priority of the CPU substitution command as high. The processing performed by the IO command is the processing of transmitting/receiving the processing result corresponding to a user's input and the processing result of the server device 2 between the terminal device and the server device 2, demanding immediacy. Since the IO command largely affects the user operational performances, the interrupt detection section 151 stores the priority of the IO command as extra-high.

Returning to FIG. 5, description will be made. The interrupt detection section 151 receives the interrupt notification from the interrupt detection section 213 of the system controller 21, and detects an interrupt. The interrupt detection section 151 determines the detected interrupt as the failure command, the CPU substitution command, or the IO command.

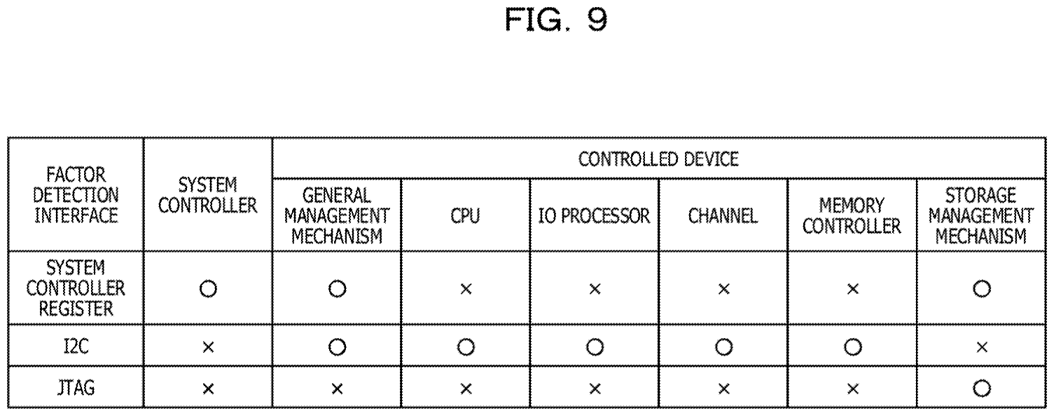

The interrupt determination processing of the interrupt detection section 151 will be described below. FIG. 9 is a table illustrating interfaces used for factor detection. As illustrated in FIG. 9, whether the device generating an interrupt is the system controller 21 or the controlled device 200 under control of the general management mechanism may be determined from information stored in an interrupt register (not illustrated) of the system controller 21. Using I2C, it may be determined which of the general management mechanism, and the CPU 221, the IO processor 223, the channel, the memory controller 224, and the storage management mechanism, which are under control of the general management mechanism, generates the interrupt. Using JTAG, it may be determined that the storage management mechanism is the device that generates the interrupt.

The interrupt detection section 151 refers to the interrupt register of the system controller 21. In this manner, the interrupt detection section 151 determines whether the interrupt notification is issued from the system controller 21 or the controlled device 200 such as the CPU 221, the memory 222, and the IO processor 223 of the server device 2. When the interrupt notification is issued from the system controller 21, the interrupt detection section 151 determines the interrupt notification as the failure notification issued from the system controller 21. When the interrupt notification is issued from controlled device 200, the interrupt detection section 151 requests the re-registration section 152 to issue the control command for identifying the device. The interrupt detection section 151 requests the re-registration section 152 to issue the control command for detecting the target type. The interrupt detection section 151 receives a response to each of the transmitted control commands from the DMA processing section 104. The interrupt detection section 151 determines whether or not the interrupt generated from the received response is the failure notification.

Returning to FIG. 5, description will be made. When the detected interrupt is the failure notification having low priority, the interrupt detection section 151 registers the interrupt notification together with information about the device having the failure in the memory 106. The interrupt detection section 151 notifies the occurrence of the interrupt to the interrupt notification section 153.

When the detected interrupt is the CPU substitution command or the IO command having high priority, the interrupt detection section 151 requests the re-registration section 152 to generate the control command for detecting the interrupt factor.

When the detected interrupt is the interrupt issued from the controlled device 200, the interrupt is re-registration section 152 is requested to issue the control command for identifying the device and the control command for detecting the target type from the interrupt detection section 151. The re-registration section 152 generates the control command for identifying the device and the control command for detecting the target type. The re-registration section 152 outputs the generated control command for identifying the device and control command for detecting the target type to the descriptor re-generation section 103.

When the interrupt is not the failure notification, the re-registration section 152 is requested to generate the control command for detecting the interrupt factor from the interrupt detection section 141. The re-registration section 152 generates the control command for detecting the interrupt factor. The re-registration section 152 outputs the control command for detecting the interrupt factor to the re-registration section 152. The re-registration section 152 notifies execution of the interrupt factor detection processing to the interrupt notification section 153, The re-registration section 152 is an example of “command generation section”.

When the interrupt is the failure notification, the interrupt notification section 153 receives the interrupt notification from the interrupt detection section 151. The interrupt notification section 153 outputs the interrupt notification to the system control interrupt processing section 102.

When the interrupt is the CPU substitution command or the JO command, the interrupt notification section 153 receives the notification of the execution of the interrupt factor detection processing from the re-registration section 152. The interrupt notification section 153 sends the notification of the interrupt processing corresponding to the interrupt factor stored in the memory 106 to the system control interrupt processing section 102.

The completion detection section 107 receives the notification that the control command has been executed from the DMA processing section 104. The completion detection section 107 determines whether or not all of the control commands included in the unified command have been executed. When all of the control commands included in the unified command have been executed, the notification that the unified command has been executed is sent to the command processing section 101.

When the interrupt is the failure notification, the system control interrupt processing section 102 receives the interrupt notification from the interrupt notification section 153. The system control interrupt processing section 102 generates the control command that executes the interrupt factor detection processing, and outputs the generated control command to the command processing section 101.

When the interrupt is the CPU substitution command or the IO command, system control interrupt processing section 102 receives a notification of the interrupt processing corresponding to the interrupt factor stored in the memory 106 from the interrupt notification section 153. The system control interrupt processing section 102 generates the control command that executes the interrupt processing corresponding to the interrupt factor stored in the memory 106 to the command processing section 101.

The system controller 21 has the DMA controller 211, an I2C controller 212, and the interrupt detection section 213.

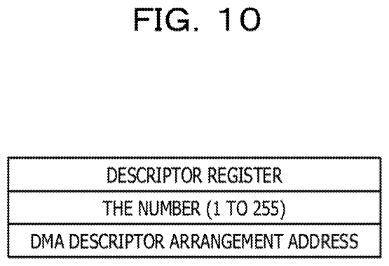

The DMA controller 211 receives a command data address of one control command. The DMA controller 211 sets the number of control commands and a DMA descriptor arrangement address in its system control descriptor register as illustrated in FIG. 10. FIG. 10 is a view illustrating an example of the descriptor register of the system controller. In the present embodiment, the processing is performed for each control command and thus, the number of the control commands is 1. A memory address viewed from the system controller 21 is fixedly used as the DMA descriptor arrangement address in FIG. 10.

The DMA controller 211 acquires data stored at the DMA descriptor arrangement address, and instructs the I2C controller 212 to transfer by I2C. The DMA controller 211 acquires data transferred from the server board 22 by DMA from the I2C controller 212. The DMA controller 211 stores the acquired data at an address in the memory 106, which is designated by DMA transfer.

The I2C controller 212 receives an instruction to transfer data by I2C from the DMA controller 211. Using I2C, the I2C controller 212 transmits the data to the controlled device 200 on the server board 22. The I2C controller 212 receives the data from the memory controller 224 on the server board 22. The I2C controller 212 outputs the acquired data to the DMA controller 211.

The interrupt detection section 213 receives the interrupt notification from the controlled device 200 on the server board 22 to detect the occurrence of the interrupt. The interrupt detection section 213 writes information indicating which of the general management mechanism, the storage management mechanism, and the system controller 21 generates the interrupt notification in a registry of its own. The interrupt detection section 213 outputs the interrupt notification to the interrupt detection section 151 on the SVP board 1.

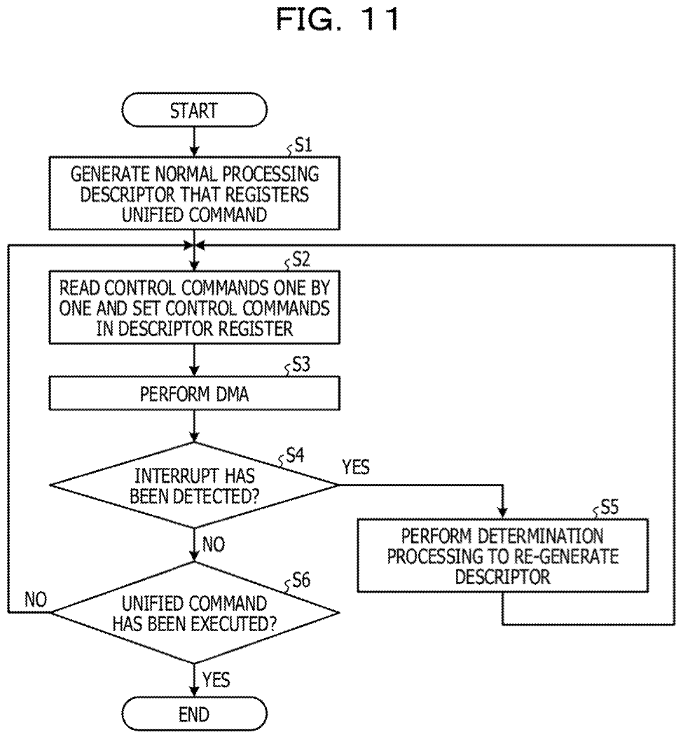

Referring to FIG. 11, an overall flow of the processing of the control command by the SVP board 1 will be described below. FIG. 11 is a flowchart of the processing of control commands by the SVP board.

The command processing section 101 receives the unified command consisting of a plurality of control commands inputted from the terminal device. The command processing section 101 secures the shared memory 108, and generates the normal processing descriptor that registers the unified command therein (STEP S1).

The descriptor re-generation section 103 reads the control command one by one from the normal processing descriptor or the interrupt processing descriptor in the shared memory 108 according to the order in the descriptor. In this case, when the descriptor including the command for processing the interrupt has been re-generated, the descriptor re-generation section 103 preferentially the control commands registered in the interrupt processing descriptor. The DMA processing section 104 acquires the control commands read by the descriptor re-generation section 103, and sets the read control command to the descriptor register of the system controller 21 (STEP S2).

The DMA processing section 104 instructs the DMA controller 211 to perform DMA transfer. Using the information stored in the descriptor register, the DMA controller 211 performs DMA transfer to the controlled device 200 via the I2C controller 212 (STEP S3).

The determination section 105 determines whether or not the interrupt has been detected based on the presence or absence of the interrupt notification from the interrupt detection section 213 of the system controller 21 (STEP S4). When the interrupt has been detected (STEP S4: Yes), the determination section 105 determines whether or not interrupt priority processing is performed, and generates a control command for detecting the interrupt factor according to the determination result. The descriptor re-generation section 103 adds the control command for detecting the interrupt factor, which is acquired from the determination section 105, to re-generate the descriptor (STEP S5). Then, the descriptor re-generation section 103 returns to STEP S2.

When the interrupt has not been detected (STEP S4: No), the descriptor re-generation section 103 determines whether or not the unified command has been executed (STEP S6). For example, when all of the control commands included in the unified command have been executed, the descriptor re-generation section 103 determines that the unified command has been executed.

When the unified command has not been executed (STEP S6: No), the descriptor re-generation section 103 returns to STEP S2. When the unified command has been executed (STEP S6: Yes), the command processing section 101 completes the processing, and returns a response to the terminal device.

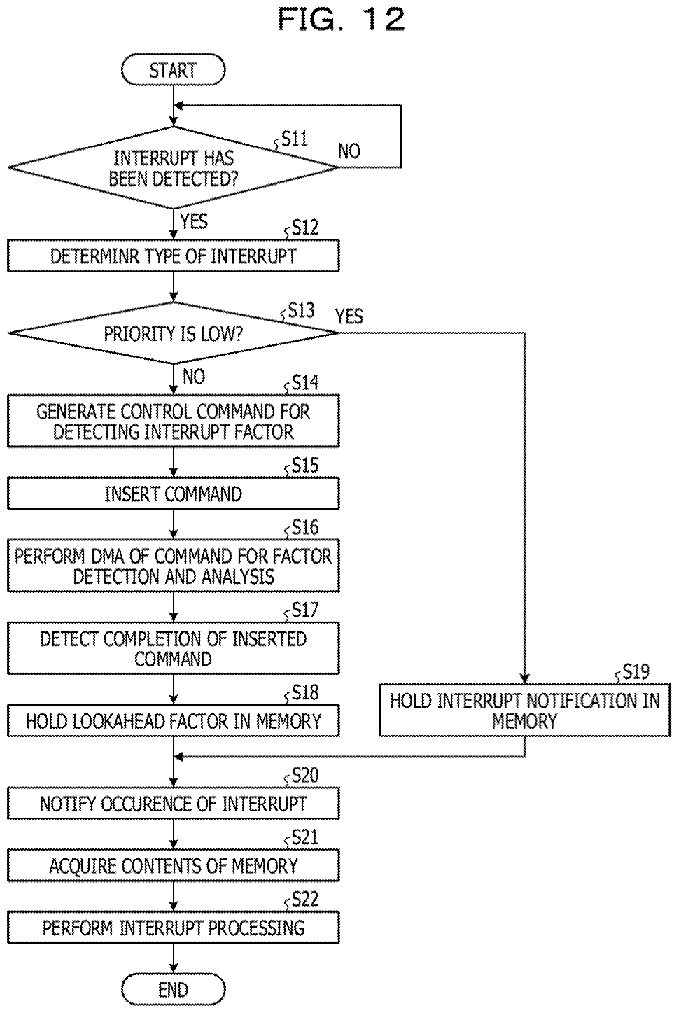

Referring to FIG. 12, a flow of the processing at the occurrence of the interrupt will be described in detail. FIG. 12 is a flowchart illustrating details of the processing at the occurrence of an interrupt.

The interrupt detection section 151 determines whether or not the interrupt has been detected (STEP S11). When the interrupt has not detected (STEP S11: No), the interrupt detection section 151 waits for the detection of the interrupt.

When the interrupt has been detected (STEP S11: Yes), the interrupt detection section 151 checks the interrupt register of the system controller 21 to determine whether the interrupt is the interrupt issued from the system controller 21 or the interrupt issued from the general management mechanism on the server board 22. When the interrupt is the interrupt issued from the system controller 21, the interrupt detection section 151 determines that the interrupt is the failure notification. When the interrupt is the interrupt issued from the general management mechanism on the server board 22, the interrupt detection section 151 requests the re-registration section 152 to generate the control command for identifying the device and the control command for detecting the target type. The re-registration section 152 generates the control command for identifying the device and the control command for detecting the target type, and outputs the generated control commands to the descriptor re-generation section 103. The descriptor re-generation section 103 adds the control command for identifying the device and the control command for detecting the target type to re-generate the descriptor in the shared memory 108. The descriptor re-generation section 103 and the DMA processing section 104 processes the control command for identifying the device and the control command for identifying the target type. The interrupt detection section 151 acquires response results of the control command for identifying the device and the control command for identifying the target type from the DMA processing section 104. Using the acquired response results, the interrupt detection section 151 determines the interrupt as any of the failure detection, the CPU substitution command, and the IO command. Through the above-mentioned processing, the interrupt detection section 151 determines the type of the interrupt (STEP S12).

The interrupt detection section 151 determines whether or not the priority of the detected interrupt is low (STEP S13). In the present embodiment, when the interrupt is the failure notification, the interrupt detection section 151 determines the priority of the interrupt as low.

When the priority of the interrupt is not low (STEP S13: No), the interrupt detection section 151 requests the re-registration section 152 to generate the control command for detecting the interrupt factor. The re-registration section 152 receives the request from the interrupt detection section 151, and generates the control command for detecting the interrupt factor (STEP S14).

The re-registration section 152 outputs the generated control command for detecting the interrupt factor to the descriptor re-generation section 103. The re-registration section 152 notifies the execution of the interrupt factor detection processing to the interrupt notification section 153. The descriptor re-generation section 103 registers the control command for detecting the interrupt factor, which is inputted from the re-registration section 152, in the interrupt processing descriptor in the shared memory 108. The descriptor re-generation section 103 inserts the control command for detecting the interrupt factor between the control command being executed and the next control command in the unified command to the descriptor (STEP S15).

The descriptor re-generation section 103 and the DMA processing section 104 perform DMA transfer of the control command for detection and analysis of the interrupt factor (STEP 516).

The DMA processing section 104 detects that inserted control command has been executed (STEP S17).

The DMA processing section 104 holds a lookahead factor acquired as an execution result of the control command for detection and analysis of the interrupt factor in the memory 106 (STEP 518). The re-registration section 152 notifies the execution of the interrupt factor detection processing to the interrupt notification section 153.

When the priority of the interrupt is low (STEP S13: Yes), the interrupt detection section 151 holds information about the device issuing the failure notification and the interrupt notification in the memory 106 (STEP S19). The interrupt detection section 151 notifies the occurrence of the interrupt to the interrupt notification section 153.

The interrupt notification section 153 notifies the occurrence of the interrupt to the system control interrupt processing section 102 (STEP S20). The system control interrupt processing section 102 acquires the information about the device issuing the failure notification and the interrupt notification from the memory 106, or acquires the lookahead factor from the memory 106 (STEP S21).

The system control interrupt processing section 102 generates a control command for executing the interrupt processing based on the information about the device issuing the failure notification and the interrupt notification, or the lookahead factor, and outputs the control command to the command processing section 101. The command processing section 101 registers the control command acquired from the system control interrupt processing section 102 in the normal processing descriptor. When the unified command has been executed, the command processing section 101 receives a notification that the unified command has been executed from the completion detection section 107. The command processing section 101 instructs the descriptor re-generation section 103 to execute the control commands acquired from the system control interrupt processing section 102, which are registered in the normal processing descriptor. The descriptor re-generation section 103 receives the instruction from the command processing section 101, and along with the DMA processing section 104, executes the control command for performing the interrupt processing registered in the normal processing descriptor, thereby performing the interrupt processing (STEP S22).

As described above, the SVP in accordance with the present embodiment divides one unified control command into commands and executes the divided commands one by one, and at detection of the interrupt during the execution of the control commands, inserts and performs the interrupt factor detection processing between the control command according to the priority of the interrupt. This may detect the interrupt factor without waiting for the execution of all of the commands included in one unified control command, to improving processing performances in the interrupt processing.

If the DMA controller of the system controller fails, when the interrupt is processed after all of the control commands included in one set have been executed, the driver detects the abnormality with a delay, generating a delay of a response to the control command to be executed, or making retry difficult. The SVP in accordance with the present embodiment may rapidly detect possible abnormalities, rapidly deal with troubles, and improve the reliability of the system.

### Embodiment 2

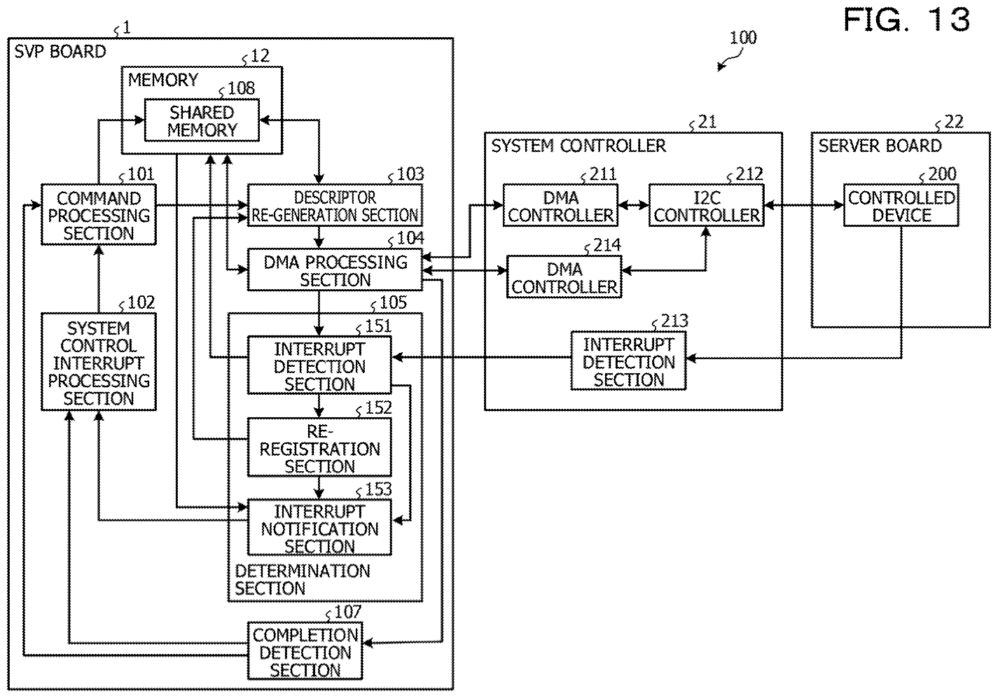

FIG. 13 is a block diagram illustrating the information processing system in accordance with Embodiment 2. The system controller 21 in accordance with the present embodiment has a DMA controller 214 in addition to the DMA controller 211. The information processing system in the present embodiment is different from the information processing system in Embodiment 1 in that is has the DMA controller 211 that processes control commands registered in the normal processing descriptor and the DMA controller 214 that processes control commands registered in the interrupt processing descriptor. Hereinafter, description the same parts as those in Embodiment 1 is omitted.

The DMA processing section 104 causes the DMA controller 211 to process control commands registered in the normal processing descriptor. The interrupt detection section 151 detects an interrupt, and when the priority of the interrupt is not low, the DMA processing section 104 stops the DMA controller 211. The DMA processing section 104 causes the DMA controller 214 to execute the control commands registered in the interrupt processing descriptor. When the control commands registered in the interrupt processing descriptor have been executed, the DMA processing section 104 causes the DMA controller 211 to restart the processing.

Stop and start of the operation of the DMA controller 211 may be controlled as follows. For example, a DMA controller register that stops and starts the operation of the DMA controllers 211 and 214 is disposed in the system controller 2L The DMA processing section 104 writes a value into the DMA controller register of the system controller 21, thereby controlling stop and start of the operation of the DMA controller 211.

The system controller 21 has the DMA controllers 211 and 214. The DMA controller 211 is instructed to perform DMA from the DMA processing section 104, and sequentially execute the control commands registered in the normal processing descriptor. In response to an instruction to stop the operation from the DMA processing section 104, the DMA controller 211 stops its operation. At this time, the DMA controller 211 stores a lastly-executed control command among the control commands registered in the normal processing descriptor. In response to an instruction to restart the operation from the DMA processing section 104, the DMA controller 211 restarts the execution of the control command following the lastly-executed command described above.

In response to an instruction to perform DMA from the DMA processing section 104, the DMA controller 214 sequentially processes the control commands registered in the interrupt processing descriptor. The DMA controller 211 is an example of “first control section”. The DMA controller 214 is an example of “second control section”.

As described above, the SVP in accordance with the present embodiment causes one system controller to execute the control commands registered in the normal processing descriptor, and the other system controller to execute the control commands registered in the interrupt processing descriptor. Even when the two DMA controllers are used, the interrupt processing of high priority may be preferentially performed over the execution of the control commands included in the unified command, improving processing performances in the interrupt processing.

When one of the two DMA controller of the system controller has a trouble, the other DMA controller may continue processing, thereby ensuring redundancy of the system.

In the above description, when the priority of the interrupt is high, detection of the interrupt factor is preferentially performed over the execution of the control commands included in the unified command and however, the selection of the interrupt for which the interrupt factor is detected is not limited to this. In the case of any interrupt, the execution of the control commands included in the unified command may be suspended, and the interrupt factor may be detected first. In the case of the IO command of extra-high priority, the interrupt factor may be detected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a control circuit;
an interface circuit; and
an information processing circuit, wherein
the control circuit is configured to:
execute a first processing that includes causing the information processing circuit to individually execute a plurality of divided first control commands as one processing unit in a predetermined execution order, via the interface circuit;
execute an interrupt detection processing that includes detecting an interrupt issued from the information processing circuit or the interface circuit;
execute a command generation processing that includes generating a second control command for identifying an interrupt factor of the interrupt detected by the interrupt detection processing; and
execute a processing order change processing that includes preferentially arranging the second control command generated by the command generation processing over the unexecuted first control commands to change the execution order.

2. The information processing apparatus according to claim 1, wherein the interrupt detection processing is configured to
determine priority of the detected interrupt,
select the interrupt based on the priority, and
cause the command generation processing to generate the second control command.

3. The information processing apparatus according to claim 1, wherein
the interface circuit includes a first control circuit and a second control circuit, the first and second control circuit being configured to execute the control command, and
in executing the first control commands and the second control command in the execution order, the processing circuit is configured to
cause the first control circuit to execute the control commands at execution of the first control commands,
stop the operation of the first control circuit,
cause the second control circuit to perform processing at execution of the second control command, and
restart the operation of the first control circuit to execute the first control commands at completion of the execution of the second control command.

4. The information processing apparatus according to claim 1,
wherein the control circuit is further configured to
execute a registration processing that includes
acquiring a unified command including the plurality of first control commands, and
registering all of the first control commands included in the unified command as the one processing unit in the execution order, in a storage area,
wherein the first processing is configured to
individually acquire the plurality of first control commands registered as one processing unit in the storage area in the execution order, and
cause the information processing circuit to sequentially execute the first control commands via the interface circuit.

5. A control method for an information processing apparatus including a control device, an interface device, and an arithmetic processing device, wherein
the control device is configured to:
cause the arithmetic processing device to individually execute a plurality of divided first control commands as one processing unit in a predetermined execution order, via the interface device;
detect an interrupt issued from the arithmetic processing device or the interface device;
generate a second control command for identifying an interrupt factor of the detected interrupt;
preferentially arrange the generated second control command over the unexecuted first control commands to change the execution order; and
execute the first control commands and the second control command in the changed execution order.

6. A non-transitory computer-readable storage medium for storing a control program which causes an information processor to perform processing, the information processor including a control device, an interface device, and an arithmetic processing device, the processing comprising:
causing the arithmetic processing device to individually execute a plurality of divided first control commands as one processing unit in a predetermined execution order, via the interface device;
detecting an interrupt issued from the arithmetic processing device or the interface device;
generating a second control command for identifying an interrupt factor of the detected interrupt;
preferentially arranging the generated second control command over the unexecuted first control commands to change the execution order; and
executing the first control commands and the second control command in the changed execution order.
